(19) United States
(12) Patent Application Publication
(10) Pub. No.: US 2017/0343948 A1
(43) Pub. Date: Nov. 30, 2017

(54) ELECTRO-PHOTOGRAPHIC SHEET OF PAPER DUPLEX PRINTING MACHINE

(71) Applicant: MIYAKOSHI PRINTING MACHINERY CO., LTD., Narashino-shi (JP)

(72) Inventors: Hideo IZAWA, Narashino-shi (JP); Kenji TAKAHASHI, Narashino-shi (JP); Yuuichi YAMAZAKI, Narashino-shi (JP)

(73) Assignee: MIYAKOSHI PRINTING MACHINERY CO., LTD., Narashino-shi (JP)

(21) Appl. No.: 15/488,075

(22) Filed: Apr. 14, 2017

(30) Foreign Application Priority Data
May 27, 2016 (JP) 2016-106752

(51) Int. Cl. G03G 15/00

(52) U.S. Cl. CPC G03G 15/657

(57) ABSTRACT

The electro-photographic sheet of paper duplex printing machine includes a sheet supply section, a sheet positioning section which positions sheets and sends out sheets to a backup roller in an electro-photographic printing section, the electro-photographic printing section transfers an image which has been transferred onto the transfer roller onto the sheet, a chain delivery section, a delivery section and a sheet carrying section for turnover. The chain delivery section selectively transfers printed sheets, which has been transferred from the backup roller to the delivery section or sheet carrying section for turnover. The sheet carrying section for turnover supplies one side printed sheet to the sheet positioning section. The sheet fed from the sheet supply section and one side printed sheet fed from the sheet carrying section for turnover are alternately carried to the sheet positioning section and the toner image on the printed sheet is fixed by the fixing device.

### TECHNICAL FIELD

The present invention relates to an electro-photographic sheet of Paper duplex printing machine for printing both front and rear sides of a sheet of paper by an electro-photographic method.

### BACKGROUND ART

An electro-photographic sheet of paper duplex printing machine for printing both sides of a sheet of paper by an electro-photographic method is heretofore disclosed in JP 2009-163064 A, JP 2013-107760 A and JP 2015-11178 A. In addition, in the following explanation, the sheet of paper will be explained simply as a sheet.

The duplex printing machine disclosed in JP 2009-163064 A and JP 2013-107760 A, comprises a sheet supply section, an electro-photographic printing section, a print sheet carrying section, a print sheet discharge section, a sheet inversing (turnover) section continued from the print sheet carrying section and performing a switchback for inversing front and back sides (up and down) of an one side printed sheet by reciprocating the sheet through a switching path, and an one side printed sheet carrying path for carrying the one side printed sheet inversed up and down to the printing section, and is configured to invert the one side printed sheet and then to carry to the printing section, then to print on its inversed side and then to carry to the print sheet discharge section as a both sides printed sheet.

The duplex printing machine disclosed in JP 2015-11178 A, comprises a sheet supply section, a sheet carrying section, an electro-photographic printing section, a sheet carrying section for inversed sheet to feed the one side printed sheet and to drop it onto the sheet carrying section, a printed sheet carrying section and a print discharge section, and is configured to inverse and carry the one side printed sheet to the printing section, then to print on its inversed side for making a both side printed sheet, then carry it to the print sheet discharge section as the both sides printed sheet through the printed sheet carrying section.

The duplex printing machine disclosed in JP 2009-163064 A and JP 2013-107760 A, the one side printed sheet is turned over by reciprocating (switching back) the sheet through a switching path and carries the one side printed sheet to the printing section, when printing the other side of the one side printed sheet.

However, in above mentioned structure in which the one side printed sheet is turned over and carried to the printing section, only one piece of the one side printed sheet at most is permitted to be in the switchback path, the following one side printed sheet cannot be sent into the switchback path until preceding one piece of the one side printed sheet passes through the switchback path.

Therefore, a carrying interval of the sheets is lengthened, as a result, the time required for print processing number of sheets per time becomes longer, resulting in a reduction of print efficiency.

The duplex printing machine disclosed in JP 2015-11178 A, the one side printed sheet is turned over by dropping the sheet during carrying it onto the sheet carrying section and carries the front and back inversed sheet to the printing section, when printing the other side of the one side printed sheet.

However, in above mentioned structure in which the one side printed sheet is turned over and then carried to the printing section, since the sheet carrying section carries alternately a prescribed number of sheets, which are sheets fed from the sheet supply section and the sheets being dropped from the sheet turnover carrying section, the sheet carrying section is needed always to continue to work for sake of efficiency of the print and so forth.

Therefore, since the one side printed sheet is dropped onto the sheet carrying section during its carrying operation when printing the other side of the one side printed sheet, register of the top and bottom of the one side printed sheet is rendered to be unstable and so the register of the top and bottom of the one side printed sheet may come out of alignment.

Besides, the one side printed sheet may be piled up on the other one side printed sheet dropped in ahead, if the space in the carrying direction between the one side printed sheets dropped onto the sheet carrying section is small, thus the space in the carrying direction between the one side printed sheets should be made wide.

In addition, the interval between the sheets of the predetermined number in the carrying direction according to a time interval from the completion of feeding of the sheets from the sheet supply section to the start of feeding of subsequent sheets should also be made wide. In other words, a time interval from the completion of feeding of a prescribed number of sheets from the sheet supply section to starting of feeding of subsequent of prescribed number of sheet from the sheet supply section should be made wide to make wide the space in the carrying direction between the prescribed number of sheets.

Therefore, the print efficiency at the time of the duplex printing is reduced.

In addition, in the duplex printing machine disclosed in JP 2015-11178 A, the printed sheet carrying section and the sheet carrying section for turnover are individually arranged and the temporary fixing devices for temporarily fixing the printed image are individually arranged at two places, therefore it has high cost and setting space becomes large.

Furthermore, the duplex printing machine disclosed in JP 2015-11178 A is configured to print the other sides of the same number of the inversed one side printed sheets after having printed one sides of the several sheets in succession and then to fix the images printed on the both side printed sheets by using the fixing device, when performing a duplex printing.

In this configuration, several both side printed sheets are successively carried to the fixing device, thereafter no sheet is carried for a certain time which is same time length as that for carrying sheets. After laps of the certain time, several both side printed sheets will be carried in succession again.

In this case, a temperature change in the fixing device at the time of printing is large, because the temperature change is repeated such that the temperature in the fixing device decreases temporarily when the both side printed sheets pass through the fixing device in succession and rises again when no both side printed sheet pass through the fixing device, and thereby difference in the quality of the product is caused.

The present invention is made to solve the problems mentioned above and seeks to provide an electro-photographic sheet of paper duplex printing machine in which a duplex printing can be efficiently performed without out of alignment of top and bottom register of the one side printed sheet at the time of a duplex printing, and its cost is small and its setting space can be small, still more, the temperature change in the fixing device at the time of printing is small and thereby the quality of the product can be stabilized.

### DISCLOSURE OF THE INVENTION

The present invention provides an electro-photographic sheet of paper duplex printing machine having a sheet supply section, a sheet positioning section, an electro-photographic printing section, a chain delivery section and a delivery section arranged in order from upstream to downstream in a direction of carriage of sheets of paper, and having a sheet carrying section for turnover disposed above the sheet supply, wherein
the sheet supply section sends out sheets one by one onto the sheet positioning section,
the sheet positioning section positions the sheets and sends out positioned sheets to a backup roller in the electro-photographic printing section,
the electro-photographic printing section prints a toner image on a sheet transferred onto the transfer roller onto the sheet on the backup roller by transferring the toner image,
the chain delivery section selectively transfers printed sheets transferred from the backup roller to the delivery section or the sheet carrying section for turnover,
the delivery section has a fixing device for fixing the toner image,
the sheet carrying section for turnover is supplied with one side printed sheet dropped from the chain delivery section, and supplies the one side printed sheet to the sheet positioning section by a suction conveyer which is intermittently driven, and
the sheet fed from the sheet supply section and the one side printed sheet carried from the sheet carrying section for turnover are alternately carried to the sheet positioning section, and the printed sheet passes through the fixing device in the delivery section at regular intervals.

In the electro-photographic sheet of paper duplex printing machine of the present invention, the sheet positioning section has a suction conveyer carrying the sheet at a constant speed and a pair of upper and lower registration rollers, the backup roller has a sheet support, the sheet horizontally carried by the suction conveyer in the sheet positioning section horizontally enters the pair of upper and lower registration rollers and comes to a stop when coming in contact with the contact portions of the pair of upper and lower registration rollers, and the sheet is carried to the sheet support of the backup roller by the rotation of the pair of upper and lower registration rollers.

This permits the sheet not to rebound when the sheet is positioned and thus the sheet can be accurately positioned.

In the electro-photographic sheet of paper duplex printing machine of the present invention, the suction conveyer in the sheet positioning section comprises a straight suction conveyer which is located in parallel to the carrying direction of the sheet sent out from the sheet supply section and an inclined suction conveyer which is located at an inclination with respect to the carrying direction of the sheet, and air suction power of the inclined suction conveyer is stronger than air suction power of the straight suction conveyer.

This permits the sheet to be positioned in the direction orthogonal to the carrying direction.

In the electro-photographic sheet of paper duplex printing machine of the present invention, a drop auxiliary means to apply a downward force to the sheet when making the sheet drop is installed at the sheet dropping position where the sheet is dropped from the chain delivery section to the sheet carrying section for turnover, and
the sheet carrying section for turnover has a means to move the printed sheet in the direction orthogonal to the carrying direction.

This permits a stable dropping of the sheet onto the sheet carrying section for turnover.

According to the electro-photographic sheet of paper duplex printing machine of the present invention, a duplex printing can be efficiently performed, and there is no out of alignment of top and bottom register of the one side printed sheet at the time of a duplex printing, and its cost is small and its setting space can be small, still more, the temperature change in the fixing device at the time of printing is small, and thereby the quality of the product can be stabilized.

### BRIEF DESCRIPTION OF THE DRAWINGS

FIG. 1 is an overall structure explanatory view that illustrates an electro-photographic sheet of paper duplex printing machine of the present invention;

FIG. 2 is a front view that illustrates a structure of a sheet supply section;

FIG. 3 is a plan view that illustrates a structure of the sheet supply section;

FIG. 4 is a front view that illustrates a structure of a sheet positioning section;

FIG. 5 is a plan view that illustrates a structure of the sheet positioning section;

FIG. 6 is a plan view for explaining a positioning operation of the sheet;

FIG. 7 is a front view that illustrates a structure of an electro-photographic printing section;

FIG. 8 is an explanatory view of an operation of a registration roller;

FIG. 9 is a front view that illustrates a structure of a chain delivery section;

FIG. 10 is a front view that illustrates structures of a sheet carrying section for turnover and a sheet dropping position portion;

FIG. 11 is an explanatory view of a sheet carriage at the time of a duplex printing;

FIG. 12 is an explanatory view of a sheet carriage at the time of the duplex printing;

FIG. 13 is a front view that illustrates a structure of the chain delivery section; and

FIG. 14 is an explanatory view of a sheet carriage at the time of a one side printing.

### PREFERRED EMBODIMENT OF THE INVENTION

An embodiment of the electro-photographic sheet of paper duplex printing machine of this invention will be explained based on the drawings.

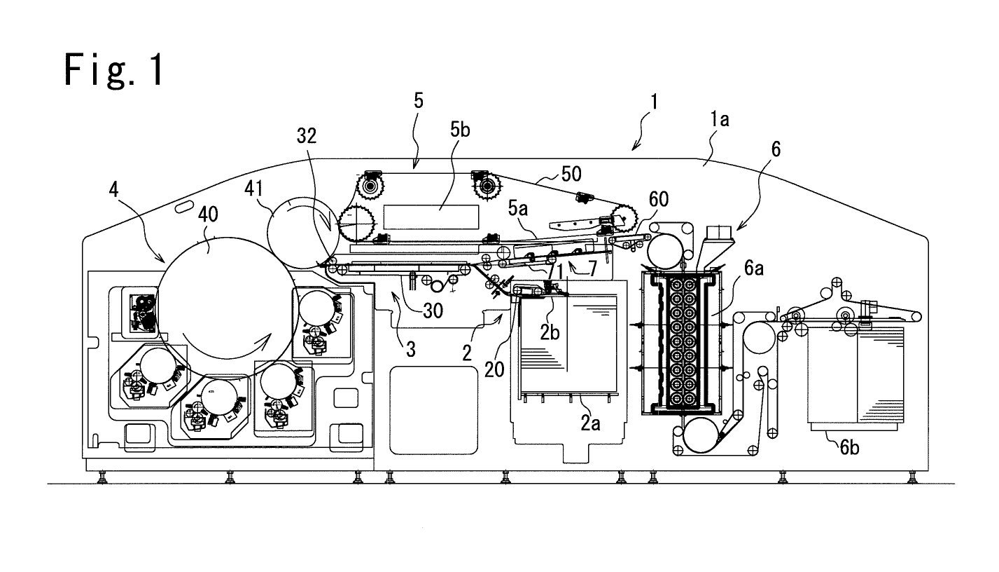

FIG. 1 is an overall structure explanatory view illustrating the electro-photographic sheet of paper dual printing machine.

As shown in FIG. 1, the electro-photographic sheet of paper dual printing machine 1 is provided with a sheet supply section 2, a sheet positioning section 3, an electro-photographic printing section 4, a chain delivery section 5, a delivery section 6 and a sheet carrying section for turnover 7, provided in order from upstream to downstream in the direction of carrying of sheets.

The sheet supply section 2 feeds sheets 2b loaded on an elevating table 2a one by one sequentially from the top and sends out the sheets 2b to a sheet positioning section 3 one by one. The sheet 2b is a sheet of paper.

The sheet positioning section 3 positions the sheet 2b sent out from the sheet supply section 2 and sends out the positioned sheet 2b to the electro-photographic printing section 4.

The electro-photographic printing section 4 is provided with a transfer roller 40 and a backup roller 41, and prints a toner image on the sheet 2b by transferring the toner image transferred onto the surface of the transfer roller 40 to the sheet 2b which is sent into from the positioning section 3, on backup roller 41. The printed sheet 2b on which the toner image is printed is carried to the chain delivery section 5 with the backup roller 41.

The chain delivery section 5 carries a printed sheet 2b on which the toner image is printed to the delivery section 6 with the printed side up. The chain delivery section 5 can be changed in its state to a first state in which the printed sheet 2b is carried up to the delivery section 6 and a second state in which the printed sheet 2b is dropped onto a sheet dropping position 5a. In other words, the printed sheet 2b is selectively carried to the delivery section 6 or the sheet carrying section for turnover 7.

The chain delivery section 5 is provided with a temporary fixing device 5b at the upstream side in the carrying direction than the sheet dropping position 5a.

The delivery section 6 is provided with a fixing device 6a to fix the image on the printed sheet 2b and an elevating table 6b, and fixes the image on the carried printed sheet 2b with the fixing device 6a and thereafter stores the printed sheet 2b by piling up the sheet on the elevating table 6b.

The sheet carrying section for turnover 7 is disposed at a position below the sheet dropping position 5a of the chain delivery section 5, and is located above the sheet supply section 2. The sheet carrying section for turnover 7 carries the printed sheet 2b dropped from the chain delivery section 5, to the sheet positioning section 3 again.

Then, the duplex printing operation to print on one side and the other side of the sheet 2b will be explained.

The sheet supply section 2 sends out the sheet 2b to the sheet positioning section 3 intermittently. In other words, the sheet supply section 2 sends out the sheet 2b intermittently so that the sheet 2b from the sheet supply section 2 and the sheet 2b from the sheet carrying section for turnover 7 are alternately sent to the sheet positioning section 3. The sheet positioning section 3 positions the sheet 2b and sends out the positioned sheet 2b to the backup roller 41.

The backup roller 41 holds a front end portion (the downstream side portion in the carrying direction.) of the sheet 2b on its peripheral surface and sends the sheet 2b to the surface of the transfer roller 40 by its rotation. A toner image is formed on the surface of transfer roller 40, and the toner image is transferred to one side of the sheet 2b on the backup roller 41, so that the toner image is printed.

The one side printed sheet 2b printed on its one side is sent to the chain delivery section 5 with the backup roller 41 and is then delivered to the chain delivery section 5.

The chain delivery section 5 carries the one side printed sheet 2b with the printed one side up, and temporarily fixes the toner image of the one side printed sheet 2b in the temporary fixing device 5b, and thereafter drops the one side printed sheet 2b on the sheet carrying section for turnover 7 at the sheet dropping position 5a. At that time, the sheet carrying section for turnover 7 is at a standstill. In other words, the chain delivery section 5 is then in the second state.

The one side printed sheet 2b dropped on the sheet carrying section for turnover 7 has the non-printed other side down.

Thereafter, the sheet carrying section for turnover 7 is driven to carry the one side printed sheet 2b to the sheet positioning section 3 with the non-printed other side down.

The sheet supply section 2 and the sheet carrying section for turnover 7 are so structured as to send the sheet 2b and the one side printed sheet 2b into the sheet positioning section 3 alternately.

The sheet positioning section 3 positions the one side printed sheet 2b and sends out the sheet to the backup roller 41.

A toner image is printed on the sheet 2b by transferring the toner image formed on the surface of the transfer roller 40 to the other side of the one side printed sheet 2b on backup roller 41.

Both side printed sheet 2b printed on its one side and the other side is sent to the chain delivery section 5 with the backup roller 41 and is then delivered to the chain delivery section 5.

The chain delivery section 5 carries the both side printed sheet 2b with the printed other side up, and temporarily fixes the toner image in the temporary fixing device 5b, and thereafter carries the sheet to the delivery section 6. That is, the chain delivery section 5 is then in the first state.

The toner image of the both side printed sheet 2b carried into the delivery section 6 is fixed with the fixing device 6a and is thereafter loaded on the elevating table 6b and stored.

At the time of the one side printing operation to print on only one side of the sheet 2b, the chain delivery section 5 should only be always in the first state and carries the one side printed sheet 2b to the delivery section 6.

In this way, according to the embodiment, since the one side printed sheet 2b is dropped onto the sheet carrying section for turnover 7 being at a standstill and is then carried to the sheet positioning section 3 by driving the sheet carrying section for turnover 7 as described above, the interval of the sheets 2b in the carrying direction can be shortened by sending the one side printed sheet 2b into the sheet positioning section 3 quickly. Besides, the top and bottom register of the one side printed sheet 2b dropped onto the sheet carrying section for turnover 7 is stabilized and the interval of the sheet 2b in the carrying direction can be shortened.

As described above, since the sheet supply section 2 and the sheet carrying section for turnover 7 are structured to send the sheet 2b and the one side printed sheet 2b into the sheet positioning section 3 alternately, the sufficient time can be ensured to allow the one side printed sheet 2 to drop onto the sheet carrying section for turnover 7 being at a standstill and to stabilize.

Therefore, the duplex printing can be efficiently performed and the top and bottom register of the one side printed sheet 2b is prevented from out of alignment at the time of the duplex printing.

In addition, since the structure to send the one side printed sheet 2b into the sheet positioning section 3 once again is composed of the chain delivery section 5 to carry the both side printed sheet 2b to the delivery section 6 and the sheet carrying section for turnover 7 disposed below the chain delivery section 5, and the temporary fixing device 5b is disposed only in the chain delivery section 5, its cost and its setting space can be more reduced in compared with those in the printer disclosed in JP 2015-11178 A.

The electro-photographic sheet of paper duplex printing machine 1 as shown in FIG. 1 can reduce its setting space still more, because the sheet dropping position 5a of the chain delivery section 5 is located above the sheet supply section 2, and the sheet turnover carrying section 7 is disposed between the sheet dropping position 5a and the sheet supply section 2.

Since the electro-photographic sheet of paper duplex printing machine 1 is constructed to send the sheet 2b from the sheet supply section 2 and the one side printed sheet 2b from the sheet carrying section for turnover 7 into the sheet positioning section 3 alternately, non-printed sheet 2b with one side to be printed and one side printed sheet 2b with the other side to be printed at the time of a duplex printing can be carried to the electro-photographic printing section 4 alternately and printed alternately, and then both side printed sheet 2b can be carried to the delivery section 6 at regular intervals, and it is possible for the double side printed sheet 2b to pass through the fixing device 6a at regular intervals.

Therefore, temperature changes in the fixing device 6a at the time of printing can be small and so the quality of the product can be stabilized.

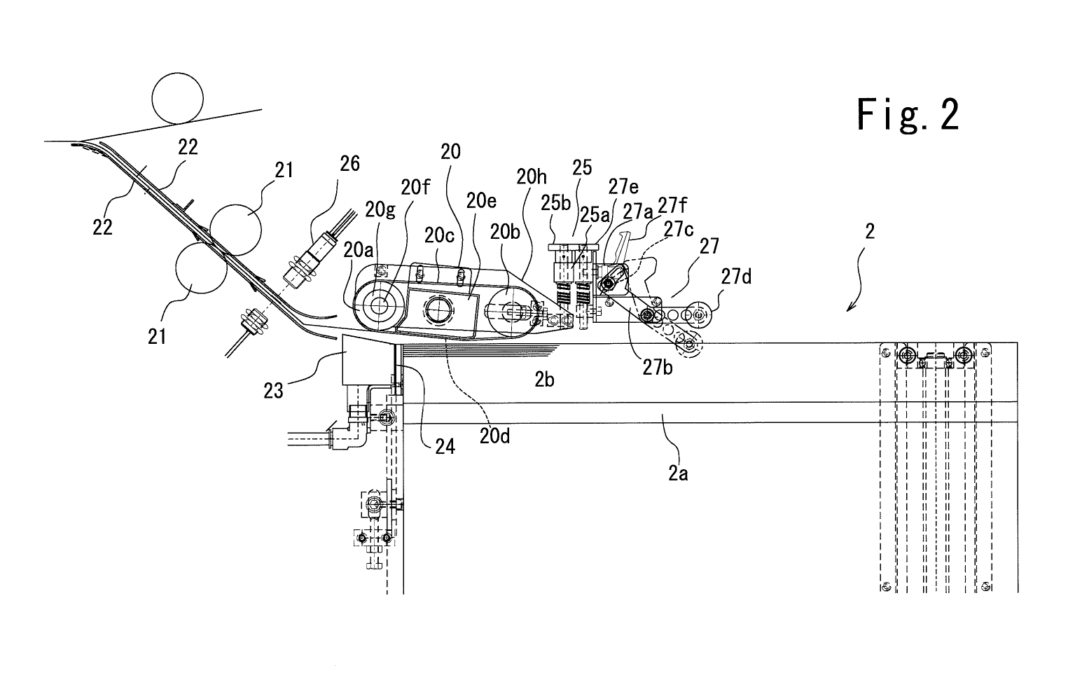

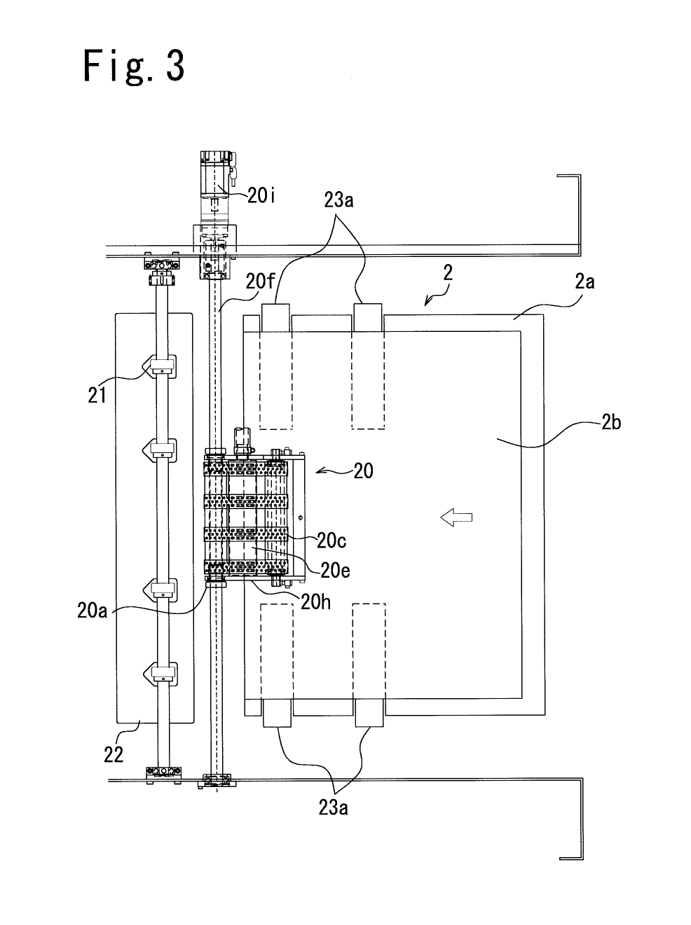

Next, the structure of the sheet supply section 2 will be explained in detail based on FIG. 2 and FIG. 3.

FIG. 2 is a front view that illustrates a structure of a sheet supply section and FIG. 3 is a plan view that illustrates a structure of the sheet supply section. In addition, the reduction scale of FIG. 3 differs from the reduction scale of FIG. 2.

The sheet supply section 2 comprises the first suction conveyer 20 carrying the sheet 2b loaded on the elevating table 2a one by one from the top, a pair of upper and lower first feed rollers 21 and a pair of upper and lower first sheet guides 22.

Since the sheets 2b loaded on the elevating table 2a are in condition to be apt to stick each other by static electricity, a plurality of the sheets 2b may be piled up and carried at a time.

To prevent this, the sheet supply section 2 is provided with an air blowing duct 23 and a projecting piece (stopper) for preventing a multi-feeding 24.

The air blowing duct 23 and sheet guides 23a for using also as air blowing ducts blow sheet handling air in 3 directions, namely blow to the end face (distal surface) of the sheet 2b at the downstream side in its carrying direction, and blow to both the lateral (right and left) end faces of the sheet 2 in the directions orthogonal to its carrying direction, whereby uppermost sheet 2b is floated by power of the air to be separated from the residue.

The end faces of the sheets 2b abut on the projecting piece 24 for a preventing a multi-feeding, and then the uppermost sheet 2b is sent out across the projecting piece for preventing a multi-feeding 24. In this way, more than one sheet 2b is prevented from sending out at a time (a multi-feeding).

The first suction conveyer 20 comprises a porous conveyer belt 20c wound around a drive roller 20a, a driven roller 20b so as to be driven and a suction duct 20e which is disposed inside of the porous conveyer belt 20c and has a suction port 20d. The first suction conveyer 20 is installed above the sheets 2b loaded on the elevating table 2a and the under surface of the porous conveyer belt 20c is opposite to the upper surface of the sheet 2b with a small gap (e.g., a gap of 0.3 mm etc.).

And the porous conveyer belt 20c sucks the sheet 2b by sucking air in the suction duct 20e with a suction machine not shown in the drawings and the porous conveyer belt 20c is turned by driving the first suction conveyer 20 and carries the sheet 2b. This air suction is always carried out during the operation of the electro-photographic sheet of paper duplex printing machine 1, but the drive of the first suction conveyer 20 is carried out intermittently. In other words, the first suction conveyer 20 is temporarily stopped to drive after it delivers the sheet 2b to the pair of first feed rollers 21.

The pair of first feed rollers 21 are disposed at the downstream side of the first suction conveyer 20 in the carrying direction.

The carrying procedure of the sheet 2b by the sheet supply section 2 will be explained in the following.

At first, the uppermost sheet 2b loaded on the elevating table 2a is sucked to the under surface of the first suction conveyer 20 (the under surface of the porous conveyer belt 20c) by sucking air in the suction duct 20e of the first suction conveyer 20. At this point of time, the first suction conveyer 20 is in the state that it is stopped to drive (the state that the porous conveyer belt 20c is stopped to turn).

And the sheet 2b is carried along the first sheet guide 22 up to the pair of first feed rollers 21 rotating at a constant speed when the first suction conveyer 20 is driven.

The timing at which the first suction conveyer 20 is driven is determined by the signal from a proximity sensor (will be explained in detail later) installed near a gear of the transfer roller 40 of the electro-photographic printing section 4. In addition, for example, the sheet carrying speed of each of the pair of first feed rollers 21 is the same as that of the backup roller 41 of the electro-photographic printing section 4 to make sure not to be different from the sheet carrying speed of the backup roller 41.

At the stage of the front end edge of the sheet 2b being put between the contact portions (nip part) of the pair of first feed rollers 21, the first suction conveyer 20 is stopped to carry.

Feed length of the sheet 2b so far is somewhat less than the top to bottom size of the shortest sheet 2b. In other words, the distance from the projecting piece for preventing a multi-feeding 24 to the contact portions of the pair of first feed rollers 21 is somewhat shorter than the top to bottom size of the shortest sheet 2b.

Hereafter, the sheet 2b is carried to the sheet positioning section 3 by the rotation of the first feed rollers 21.

A drive shaft 20f of the drive roller 20a of the first suction conveyer 20 can be driven to rotate in the carrying direction of the sheet 2b (clockwise direction in FIG. 2) by a servomotor 20i.

Furthermore, one way clutch 20g is interposed between the drive shaft 20f and the drive roller 20a, and thereby the rotation in the carrying direction of the drive shaft 20f is transmitted to the drive roller 20a by the one way clutch 20g and the drive roller 20a rotates in the carrying direction freely with respect to the drive shaft 20f. In other words, as far as the first suction conveyer 20, the porous conveyer belt 20c (the first suction conveyer 20) can freely turn only in the carrying direction of the sheet 2b (clockwise direction in FIG. 2) by the action of the one way clutch 20g even if the drive shaft 20f is at a standstill.

Thus, since the upstream portion (rear end portion) of the sheet 2b is suck to the porous conveyer belt 20c of the first suction conveyer 20 which stops the rotational driving when the sheet 2b is carried by the first feed rollers 21, a load is applied to the carriage of the sheet 2b by the first feed rollers 21, but the load can be reduced because the first suction conveyer 20 freely turns by the action of the one way clutch 20g.

When the sheet 2b suck to the first suction conveyer 20 is carried by the first feed rollers 21, a contact area between the sheet 2b and the first suction conveyer 20 gradually becomes small. In inverse proportion to this, the numbers of the suction ports of the porous conveyer belt 20c that are not blocked up by the sheet 2b increase, and a suction force for the sheet 2b of the porous conveyer belt 20c becomes small.

Accordingly the first suction conveyer 20 comes to a stop without freely turning because of a reduced rotational driving force by the sheet 2b, and thereby the sheet is carried in slide contact with the surface of the first suction conveyer 20, while it is suck by the suction force of the first suction conveyer 20 which is becoming gradually weak.

Furthermore, when the sheet 2b is carried and the rear end portion of the sheet 2b leaves a part of the suction ports 20d of the suction duct 20e near the driven roller 20b of the first suction conveyer 20, the following second sheet 2b from the top loaded on the elevating table 2a is then suck to the part of the suction ports 20d of the suction duct 20e near the stopped driven roller 20b of the first suction conveyer 20.

Thereafter the rear end portion of the preceding sheet 2b passes through the suction ports 20d of the suction duct 20e and the sucking of the preceding sheet 2b to the first suction conveyer 20 disappears, the servomotor 20i of the first suction conveyer 20 is driven and then the first suction conveyer 20 is driven by a rotation of the drive shaft 20f to carry the following stuck sheet 2b.

At this time, a timing to drive the servomotor 20i of the first suction conveyer 20 is determined as follows.

A proximity sensor is installed opposite to the gear rotationally driving the transfer roller 40 of the electro-photographic printing section 4 and to detect one revolution of the transfer roller 40. For example, this gear is attached to the transfer roller 40 coaxially with the transfer roller 40, and the transfer roller 40 rotates one revolution when this gear rotates one revolution. A detection signal from the proximity sensor and a pulse sent from a servomotor and the like not shown in the drawings, which drives the transfer roller 40 or an encoder not shown in the drawings, which is directly attached to the transfer roller 40 are taken into a control section not shown in the drawings.

The said control section outputs an operation signal mainly based on the result of calculation of a detection signal from the proximity sensor and the number of the pulses and drives the servomotor 20i of the first suction conveyer 20 by the operation signal.

In addition, the said proximity sensor sends the detection signal once per one revolution of the transfer roller 40. For example, in the case where the transfer roller 40 is a 4 times roller (roller printing four pieces of the sheets 2b at one revolution), the control section calculates a quarter of the number of the sent pulses while receiving the detection signal and outputs the operation signal when the calculated number of the pulses is input into the said control section.

In other words, since one piece of the sheet 2b is carried and printed whenever the transfer roller 40 rotates a quarter revolution, the operation signal is output every a quarter revolution of the transfer roller 40 and, in the case of a duplex printing, the servomotor 20i is driven by an every other operation signal so that the sheet 2b is carried from the sheet supply section 2 every a half revolution of the transfer roller 40.

In the case of one side printing, the servomotor 20i is driven every each operation signal so that the sheet 2b is carried from the sheet supply every a quarter revolution of the transfer roller 40. In other words, an operation signal can be linked with specific one of four toner images on the transfer roller 40. From this reason, for example, the number of the sheet stored and the position of the specific sheet 2b in the carrying section in term of the position or the phase of the specific toner image can be determined by the calculation in the said control section.

As shown in FIG. 2, the first suction conveyer 20 is inclined with respect to the horizontal plane so that its downstream side in the carrying direction becomes higher than its upstream side in the carrying direction. This inclined angle is adjustable by an angle adjustment mechanism 25 shown in FIG. 2.

In other words, a frame 20h of the first suction conveyer 20 is supported swingably up and down by a main body frame 1a of the electro-photographic sheet of paper duplex printing machine 1, a screw 25b is screwed and attached to a member 25a attached to the main body frame 1a, and the screw 25b is connected to the frame 20h, to make the angle adjustment mechanism 25.

The frame 20h is swung up or down by turning the screw 25b in tightening or loosening direction, and thereby the inclined angle of the first suction conveyer 20 is changed.

Furthermore, a two-sheet feeding detection sensor 26 is installed between the first suction conveyer 20 and the first feed rollers 21. In this embodiment, a supersonic wave-type two-sheet feeding detection sensors 26 is used, but other sensors may be used.

The sheet supply section 2 comprises a sheet height detection mechanism 27 for detecting a height of the sheet 2b loaded on the elevating table 2a.

This sheet height detection mechanism 27 has a frame 27a attached to the member 25a, an arm 27b attached swingably up and down to the frame 27a and a proximity sensor 27c attached to the frame 27a. A roller 27d attached to the arm 27b is in contact with the sheet 2b, and the arm 27b swings up and down in response to a change of height of the sheet 2b.

In the state of the arm 27b shown by a solid line in FIG. 2, the proximity sensor 27c detects the arm 27b and outputs a signal. In addition, the frame 27a is adjust in its attachment height position in the top to bottom direction to the member 25a with a screw 27e, and is thereafter fixed to the member 25 with a clamp lever 27f.

In the state of the arm 27b shown by an imaginary line in FIG. 2, the proximity sensor 27c does not output a signal because it does not detect the arm 27b.

The signal from the proximity sensor 27c is input into an elevating table control section not shown in the drawings. The elevating table control section elevates the elevating table 2a when the signal is not input, and comes to a stop when the signal is input.

Therefore, the elevating table 2a comes to a stop when the height of the sheet 2b becomes the highest (predetermined sheet feed height), because the proximity sensor 27c detects the arm 27b and outputs the signal.

When a certain number of sheets 2b is carried from this state, the height of the sheet 2b becomes lower than a certain height, and the arm 27b is in a condition as shown by an imaginary line, and the proximity sensor 27c does not output a signal, and thereby the elevating table control section elevates the elevating table 2a. And when the height of the sheet 2b becomes high to reach the highest (predetermined sheet feed height), the proximity sensor 27c outputs a signal, and thereby the elevating table control section stops to elevate the elevating table 2a.

In this way, the height of the sheet 2b is prevented from becoming lower than a certain height.

In this embodiment, the central position of the sheet 2b in the sheet supply section 2 in the direction orthogonal to the carrying direction (the right angle direction in the sheet surface, same as follows) is shifted slightly, e.g., about 5 mm in the direction orthogonal to the carrying direction from the central position in the direction orthogonal to the carrying direction of the sheet supply section 2. This is for the operation to position the sheet 2b in the sheet positioning section 3.

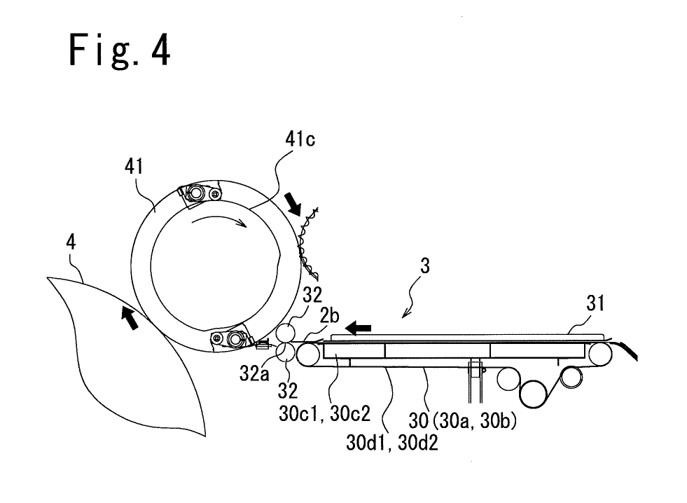

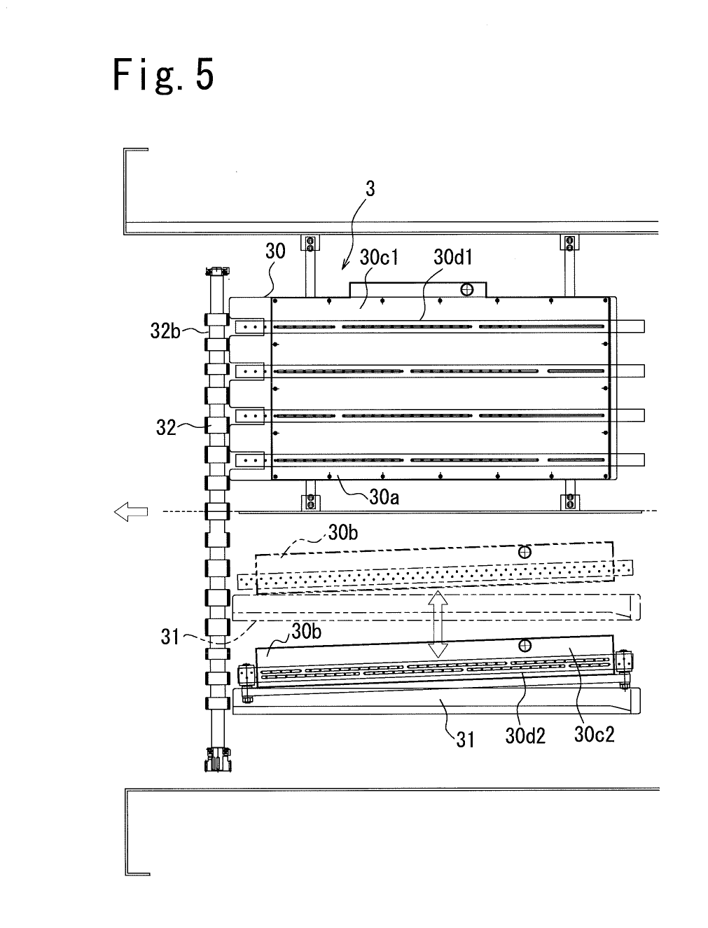

Next, the structure of the sheet positioning section 3 will be explained in detail based on FIG. 4 and FIG. 5.

The sheet positioning section 3 comprises a suction conveyer 30, a lateral positioning board 31 and a upper and lower pair of registration rollers 32, and positions to determine the position in the top to bottom direction and the position in the lateral direction of the sheet 2b sent out from the sheet supply section 2. The position in the top to bottom direction of the sheet 2b is a position in the sheet carrying direction, and the position in the lateral direction thereof is a position in the direction orthogonal to the sheet carrying direction in the sheet surface.

The suction conveyer 30 has a straight suction conveyer 30a and an inclined suction conveyer 30b installed between the lateral positioning board 31 and the straight suction conveyer 30a.

The straight suction conveyer 30a is located in parallel to the carrying direction of the sheet 2b sent out from the sheet supply section 2. The inclined suction conveyer 30b is located at a slant with respect to the direction parallel to the carrying direction of the sheet 2b (the straight suction conveyer 30a) so that its downstream side in the carrying direction (front end side) is nearer the lateral positioning board 31 than its upstream side in the carrying direction (rear end side).

The suction conveyers 30a, 30b have suction ducts 30c1 and 30c2 having suction ports and porous conveyer belts 30d1 and 30d2, and is constructed to suck the sheets 2b to the porous conveyer belts 30d1 and 30d2 by sucking air from the plurality of suction ports opened in the porous conveyer belts 30d1 and 30d2 so as to carry the sheets 2b stick to the porous conveyer belts 30d1 and 30d2, respectively. The suction conveyers 30a, 30b are so set that air suction power through the porous conveyer belt 30d2 of the inclined suction conveyer 30b is stronger than air suction power through the porous conveyer belt 30d1 of the straight suction conveyer 30a by changing number or size of the ports of the porous conveyer belt 30d1 and 30d2 or changing suction powers themselves of the suction ducts 30c1 and 30c2, respectively.

Therefore, the sheet 2b is carried to the lateral positioning board 31 diagonally by carrying power of the inclined suction conveyer 30b, and is carried to go along the lateral positioning board 31 after one of the lateral end faces of the sheet 2 comes in contact with the lateral positioning board 31, and thereby the position in the lateral direction thereof is determined.

At the time of this movement, the inclined angle and air suction power of the inclined suction conveyer 30b is so set that the sheet 2b does not get over the lateral positioning board 31. The lateral positioning board 31 is moved in parallel in the lateral direction according to size (dimensions in the lateral direction) of the sheet 2b and thereby its position in the lateral direction can be adjusted.

In addition, since the sheet carrying direction (direction of movement) of the inclined suction conveyer 30b is different from the sheet carrying direction (direction of movement) of the straight suction conveyer 30a, a force for lengthening the sheet 2b in the lateral direction is applied and can prevent the sheet 2b from bending,

In addition, behavior of the sheet 2b is stable because the sheet carrying speeds of the suction conveyers 30a, 30b (turning speeds of the porous conveyer belts 30d1 and 30d2) are uniform, respectively.

For example, the sheet carrying speed of each of the suction conveyers 30a, 30b is the same as the sheet carrying speed of the backup roller 41 of the electro-photographic printing section 4 and is prevented from varying from the sheet carrying speed of the backup roller 41. In this case, the sheet carrying speed (actual carrying speed) in the sheet carrying direction of the inclined suction conveyer 30b becomes slightly slower than the sheet carrying speeds of the backup roller 41 and the straight suction conveyer 30a by the inclination, but it does not have any problem. In addition, the sheet carrying speed in the sheet carrying direction of the inclined suction conveyer 30b may be the same as the sheet carrying speed of the backup roller 41 and the straight suction conveyer 30a.

The upper and lower pair of registration rollers 32 is installed at downstream side in the carrying direction of the suction conveyer 30.

The front end edge of the sheet 2b carried by the suction conveyer 30 comes in contact with the upstream side of contact portions (nip part) 32a of the upper and lower pair of registration rollers 32, and thereby the position in the top to bottom direction thereof is determined. The surface portion of each of the registration rollers 32 is made of a material having large coefficient of friction such as the rubber in order to prevent the sheet 2b nipped with the upper and lower pair of registration rollers 32 from slipping.

In addition, the upper registration roller 32 is provided with a plurality of cutouts 32b in order not to interfere with a sheet support (here as an example, a clamp) and a stopper projecting from the peripheral surface of the backup roller 41.

Generally speaking, when intending to pushed the sheet 2b until it comes in contact with the upstream side of the contact portions 32a of the upper and lower pair of registration rollers 32, the sheet 2b could not be entered until it comes in contact with the upstream side of the contact portions 32a of the upper and lower pair of registration rollers 32 depending on the carrying angle of the sheet 2b and the carrying power applied to the sheet 2b.

In this embodiment, the sheet 2b is horizontally carried by the suction conveyer 30, and the carrying surface of the suction conveyer 30, that is, the sheet carrying height position is the same as the height position of the contact portions 32a of the upper and lower pair of registration rollers 32. The height position is the position in the top to bottom direction.

Therefore, since the sheet 2b is moved straight towards the upstream side of the contact portions 32a of the upper and lower pair of registration rollers 32 and is pushed into the deeper inside of the gradually narrowed space that is formed between the peripheral surfaces of the upper and lower pair of registration rollers 32, the front end edge of the sheet 2b can easily come in contact with the upstream side of the contact portions 32a of the upper and lower pair of registration rollers 32, and thereby the position in the top to bottom (top and bottom) direction of the sheet 2b can easily be determined.

Furthermore, since friction develops between the upper and lower pair of registration rollers 32, and the rear end portion of the sheet 2b is suck by air suction of the suction conveyer 30 so that the carrying power is applied to the sheet 2b, the sheet 2b is prevented from rebounding on the registration roller 32 when the sheet 2b comes in contact with the upstream side of the contact portions 32a of the upper and lower pair of registration rollers 32.

In the printing machines disclosed in above described JP 2013-107760 A and JP 2015-11178 A, the front end edge of the sheet is brought into contact with an front pad (first front regulation stopper 62 of JP 2013-107760 A, front pad 23 of JP 2015-11,178 A) and is brought to a stop for positioning in the top to bottom direction.

However, rebound of the sheet generally occurs when the front end edge of the sheet running at high speed comes in contact with the front pad and comes to a stop, which results in incorrect position accuracy in the top to bottom direction of the sheet.

To prevent this, in the printing machine disclosed in JP 2013-107760 A, rebound of the sheet is tried to be prevented by strengthening the contact force of the sheet with the belt by suction of the second sucking mechanism 49, but since the part of the sheet in contact with the second sucking mechanism is structurally limited to only a part of the upstream side of the sheet when the sheet comes in contact with the front pad, its sucking effect is weak, so that rebound of the sheet cannot be surely prevented.

In the printing machine disclosed in JP 2015-11,178 A, the speed of the sheet carrying conveyer 20 is decreased when the sheet is brought into contact with the front pad in order to prevent rebound of the sheet, and then the speed of the sheet carrying conveyer 20 is increased to send the sheet into the printing section, and then the speed of the sheet carrying conveyer 20 is still further increased to carry the next sheet. However, behavior of the sheet is made unstable because the speed change of the sheet carrying conveyer 20 is large.

On the contrary, in the sheet positioning section 3 of this embodiment, the positioning in the top to bottom direction of the sheet 2b is performed by using the registration roller 32 and the suction conveyer 30, so that rebound of the sheet 2b can be surely prevented.

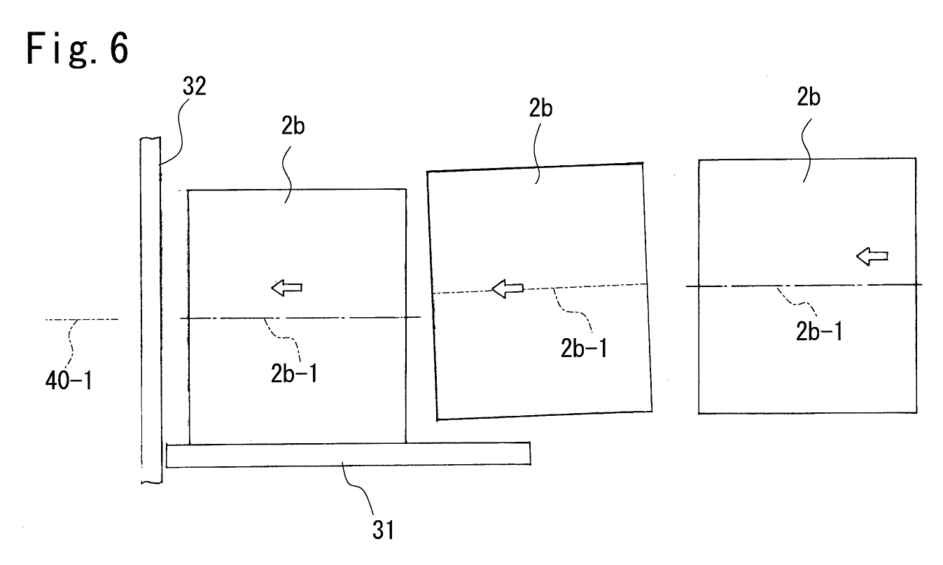

In addition, since the sheet 2b is moved in one of the lateral directions to be brought into contact with the lateral positioning board 31 in order to be positioned in the lateral direction as shown in FIG. 6, in the sheet positioning section 3, the central position in the direction to the carrying direction of the sheet 2b, i.e. the central positions 2b-1 of the sheet while carrying and the sheet after being positioned are displaced each other in the lateral direction.

And, the central position 2b-1 of the positioned sheet in the lateral direction is made matched with the central position 40-1 in the axial direction of the transfer roller 40.

Therefore, the central position 2b-1 in the lateral direction (central position in the direction orthogonal to the carrying direction) of the sheet 2b loaded on the sheet supply section 2 is displaced from the central position 40-1 in the axial direction of the transfer roller 40 (central position in the direction orthogonal to the carrying direction of the sheet supply section 2) of the transfer roller 40 and is made matched with the central position of the sheet 2b in the lateral direction just before that it is carried into the sheet positioning section 3.

In this way, the sheet 2b can be carried without bending or wrinkling from the sheet supply section 2 towards the sheet positioning section 3.

As shown in FIG. 5, the lateral positioning board 31 is attached to the inclined suction conveyer 30b and the inclined suction conveyer 30b is attached to the lateral positioning board 31, thereby the inclined suction conveyer 30b and the lateral positioning board 31 are moved as one body in the lateral direction.

Therefore, the straight suction conveyer 30a and the inclined suction conveyer 30b are separated laterally and a big space is resulted between the straight suction conveyer 30a and the inclined suction conveyer 30b, thus, when a sheet 2b of big size is carried and is positioned, a part of the sheet 2b hangs down in this space, and the positioning operation of the sheet 2b is rendered to be uncertain.

Therefore, a sheet tray, not illustrated, which is extendable and variable in its lateral dimensions, e.g., an accordion sheet tray is installed between the straight suction conveyer 30a and the inclined suction conveyer 30b.

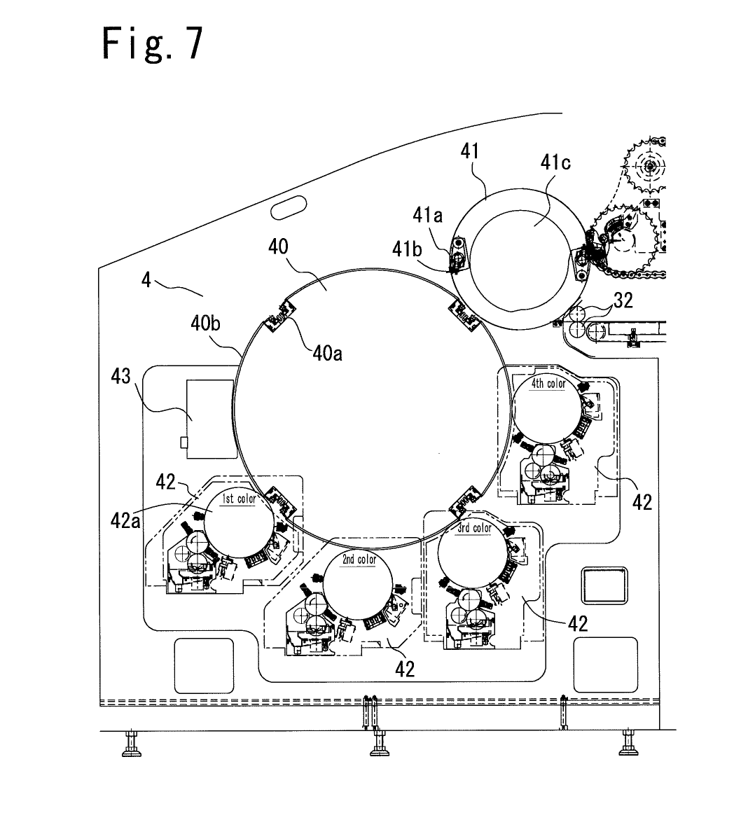

Next, the structure of the electro-photographic printing section 4 will be explained in detail based on FIG. 7.

The electro-photographic printing section 4 comprises the backup roller 41, the transfer roller 40 in contact with the backup roller 41, and the electro-photographic printing units 42 and a cleaning unit 43 which are disposed around the transfer roller 40.

The electro-photographic printing unit 42 is a printing unit of the electro-photographic type, in which an electrostatic latent image based on an image data is formed on a photoconductor drum 42a and a liquid toner is attached to this electrostatic latent image to make a toner image and the toner image is transferred to the transfer roller 40.

And, the toner image transferred to the transfer roller 40 is transferred to the sheet 2b in its rotational contact area with the backup roller 41 and is printed thereon.

In this embodiment, since the diameter of the backup roller 41 is double the diameter of the photoconductor drum 42a, two pieces of the sheet 2b can be wrapped around the peripheral surface of the backup roller 41 to be held by clamps 41a.

In addition, since the diameter of the transfer roller 40 is four times of the diameter of the photoconductor drum 42a, four toner images are transferred to the peripheral surface of transfer roller 40. The diameters of the backup roller 41 and the transfer roller 40 are not limited to these radius values.

The backup roller 41 is provided with the clamps 41a to grip the sheets 2b to hold them on the peripheral surface of the backup roller 41 and stoppers 41b serving as a reference with which the front end edge of the sheet 2b is brought into contact. The clamp 41a and the stopper 41b are projected from the peripheral surface of the backup roller 41. Cutouts 40a are formed on the peripheral surface of the transfer roller 40 in order to avoid its interference with the clamps 41a and the stoppers 41b of the backup roller 41.

In addition, a jacket 40b of the transfer roller 40 is made of a base plate of stainless steel on which a surface layer of rubber material laid, and the base plate is stretched between the adjacent cutouts 40a of the transfer roller 40 so as to stick to the transfer roller 40. In other words, the both ends of this base plate of which the surface does not have the surface layer of rubber material are fixed to the transfer roller 40 in the adjacent cutouts 40a of the transfer roller 40. And, the toner image is transferred to the surface layer of rubber material of this jacket 40b.

The sheet 2b is carried towards the backup roller 41 by the upper and lower pair of registration rollers 32 of the sheet positioning section 3, and the front end edge of the sheet 2b comes in contact with the stopper 41b of the backup roller 41 and, in that state, the front end edge of the sheet 2b is gripped and held by the clamp 41a, so that the sheet is delivered to the backup roller 41 side.

Since the position of the stopper 41b of the backup roller 41 serves as a reference position of the sheet 2b in the print, the sheet 2b is delivered so as to be in contact with the stopper 41b of the backup roller 41.

As shown in FIG. 7, the clamp 41a of the backup roller 41 is adjusted to be closed when the sheet 2b comes in contact with the stopper 41b of the backup roller 41 and to be opened when the clamp 41a moves to a delivering position close to the chain delivery section 5, by converting the motion of the cam follower moving up-and-down on the outer periphery of the cam 41c into rotational motion by mean of a cam 41c, a cam follower (not shown in the drawings) installed so as to be in rotational contact with the outer periphery of the cam 41c, a lever (not shown in the drawings) to which the cam follower is rotatably attached, and a constituent body (not shown in the drawings) having a shaft (not shown in the drawings) on which the lever and the clamp are mounted.

In other words, the clamp 41a is held open from the delivering position to the chain delivery section 5 to the delivered position (receipt position) from the sheet positioning section 3.

The cam 41c is formed in a circular shape having a large diameter part and a small diameter part and fixed on the main body frame independently from the backup roller 41. The clamp 41a is closed when the cam follower of the clamp 41a is in contact with the large diameter part of the cam 41c and opened when the cam follower of the clamp 41a is not in contact with the small diameter part of the cam 41c but is dropped toward the small diameter side. And, a phase positioning of the cam 41c is concentrically adjusted with the rotation center of the backup roller 41 so that continuation parts with the large diameter part and the small diameter part of the cam 41c corresponds to the respective positions of the sheet delivering positions.

Therefore, the cam 41c may be made of two superimposed pieces and, by doing so, the positions of the sheet receiving section and the sheet delivering section can be appropriately adjusted, respectively.

The backup roller 41 and the registration roller 32 can be located close each other by virtue of the cutouts 32b (FIG. 5) formed in the upper registration roller 32 (the registration roller 32 close to the backup roller 41) of the pair of registration rollers 32.

Accordingly, a delivery distance for delivering the sheet 2b from the registration roller 32 to the backup roller 41 is shortened and thereby an accurate transfer of the sheet is enabled.

The sheet carrying speed of the registration rollers 32 is usually the same as the sheet carrying speed of the backup roller 41, but they come to a stop when the sheet 2b carried by the suction conveyers 30a, 30b abuts against the contact portion 32a of the registration rollers 32.

Thereafter, the registration rollers 32 are driven at the speed higher than the normal sheet carrying speed thereof. Thus, the sheet carrying speed of the registration rollers 32 when delivering the sheet 2b to the clamp 41a of the backup roller 41 can be higher than sheet carrying speed of the backup roller 41.

The drive start timing of the registration roller 32 is determined by the signal from the proximity sensor installed opposite to the gear which rotationally drives the transfer roller 40 as with the suction conveyer 20 of the sheet supply section 2.

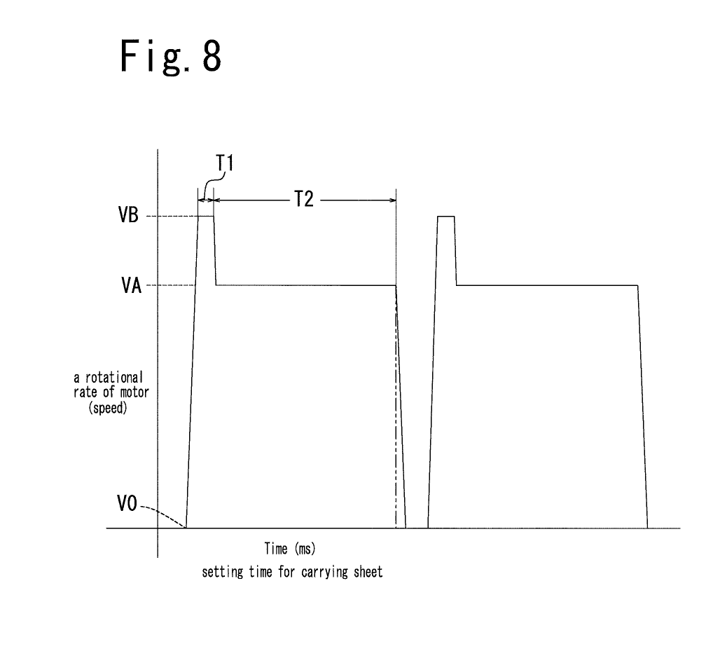

An example of the change of the sheet carrying speed of the registration roller 32 will be explained based on FIG. 8.

The sheet carrying speed is zero V0 just before the front end edge of the sheet 2b abuts against the contact portion 32a, and the drive of the registration roller is started when the front end edge of the sheet 2b abuts against the contact portion of the registration roller 32, and then the carrying speed is accelerated to the speed VB which is higher than the carrying speed VA of the backup roller 41. The registration roller 32 is driven at the speed VB for the first setting time T1. After this, the sheet carrying speed is decelerated to the carrying speed VA, and the registration roller 32 is driven at the speed VA for the second setting time T2. After the lapse of second setting time T2, the registration roller 32 is decelerated and stopped.

In this example, the registration roller 32 has a carrying speed VB higher than the sheet carrying speed VA of the backup roller 41 when delivering the sheet 2b to the clamp 41a of the backup roller 41. For example, the speed VB is optionally set at the speed not less than 105% and not more than 150% of the speed VA. If the sheet carrying speed VB is too high, the front end edge of the sheet 2b abuts too strong against the stopper 41b of the backup roller 41, and thereby malfunction such as a wrinkle produced in the sheet 2b arises.

On the contrary, if the sheet carrying speed VB is too low, paper 2b does abut against the stopper 41b of the backup roller 41, thus, the paper holding position of the backup roller 41 deviates, and thereby a misalignment of the print position and a failure of gripping the front end of the sheet 2b by the clamp 41a of the backup roller 41 will arise.

As for this, the condition changes according to the kind of the sheet 2b and the environment at the time of use. Therefore, speed VB can be arbitrarily set by a control section not shown in the drawings.

The transfer roller 40 is capable of contacting with and separating from the backup roller 41 as one body with the electro-photographic printing units 42 and the cleaning unit 43. Furthermore, the electro-photographic printing unit 42 is capable of contacting with and separating from the transfer roller 40.

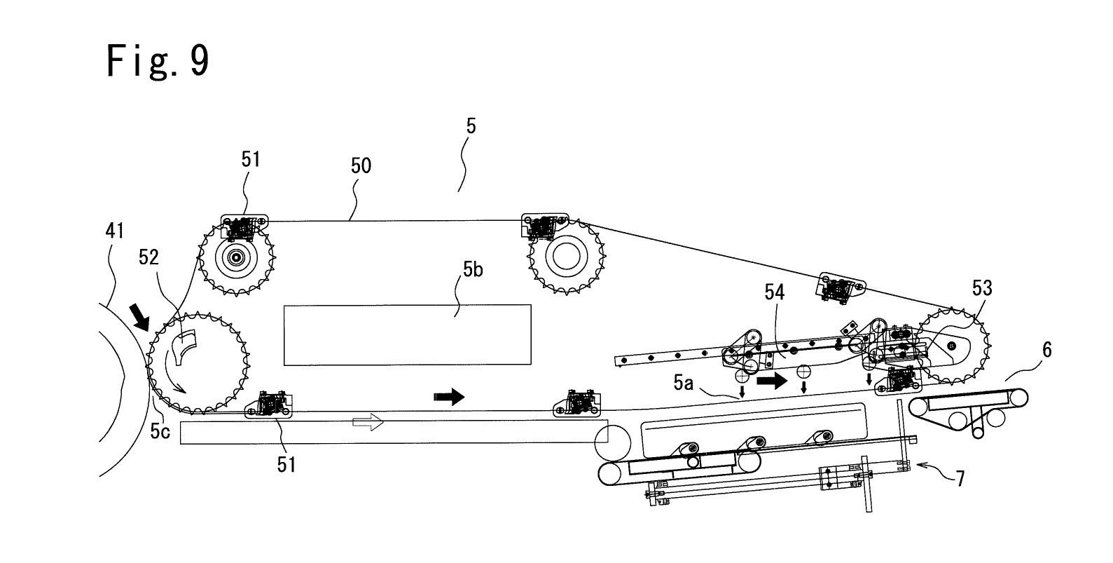

Next, the structure of the chain delivery section 5 will be explained in detail based on FIG. 9.

The chain delivery section 5 comprises an endless chain 50 which is turnably driven and grippers 51 which are attached to the chain 50. The gripper 51 is brought into open position by an opening cam 52. The opening cam 52 is located near the backup roller 41 and the gripper 51 is closed after being opened once by the opening cam 52 and holds the sheet 2b by gripping the front end of the printed sheet 2b.

Therefore, a means to grip the printed sheet 2b after printing to which a toner image was transferred is changed from the clamp 41a of the backup roller 41 to the gripper 51 of the chain delivery section 5 at a gripping change position 5c, and then the printed sheet 5b is carried towards a delivery section 6.

The temporary fixing device 5b is located between the gripping change position 5c and the sheet dropping position 5a, and a toner image on the printed sheet 2b is temporarily fixed by this temporary fixing device 5b. In this embodiment, the temporary fixing device 5b is an IR heater, and specifically it uses a carbon heater and so forth.

By temporarily fixing the toner image on the printed sheet 2b, the toner printed (transferred) on the sheet 2b is prevented from attaching to rollers in subsequent processes. In addition, complete fixing of a toner in temporary fixation is unfavorable because print quality of the back side turns worse under the influence of decreasing of water contained in the printed sheet 2b.

The gripper 51 is brought into open by an opening cam for ejection 53 and an opening cam for dropping 54.

The opening cam for ejection 53 is located near the delivery section 6. The opening cam 54 for dropping is located at the upstream side in the carrying direction than the opening cam for ejection 53 and above the sheet dropping position 5a and the opening cam 54 for dropping moves between the operating position to make the gripper 51 open and the non-operating position to hold the gripper 51 close.

In this way, the chain delivery section 5 reaches the first state when the opening cam for dropping 54 is located at the non-operating position and the printed sheet 2b is carried to the delivery section 6. The chain delivery section 5 reaches the second state when the opening cam for dropping 54 is located at the operating position and the printed sheet 2b is dropped on the sheet turnover carrying section 7 from the sheet dropping position 5a.

In other words, at the sheet dropping position 5a, the carrying path of the printed sheet 2b branches off into two. In the duplex printing, one side printed sheet 2b which only one side printing has been completed is dropped onto the sheet carrying section for turnover 7 for printing on the other side thereof. The one side printed sheet 2b which one side printing has been completed in the one side printing or the both side printed sheet 2b which both side printing has been completed in the duplex printing is sent to the delivery section 6 without being dropped.

In addition, the opening cam 54 for dropping is able to move in the sheet carrying direction to adjust its position depending on the sheet size.

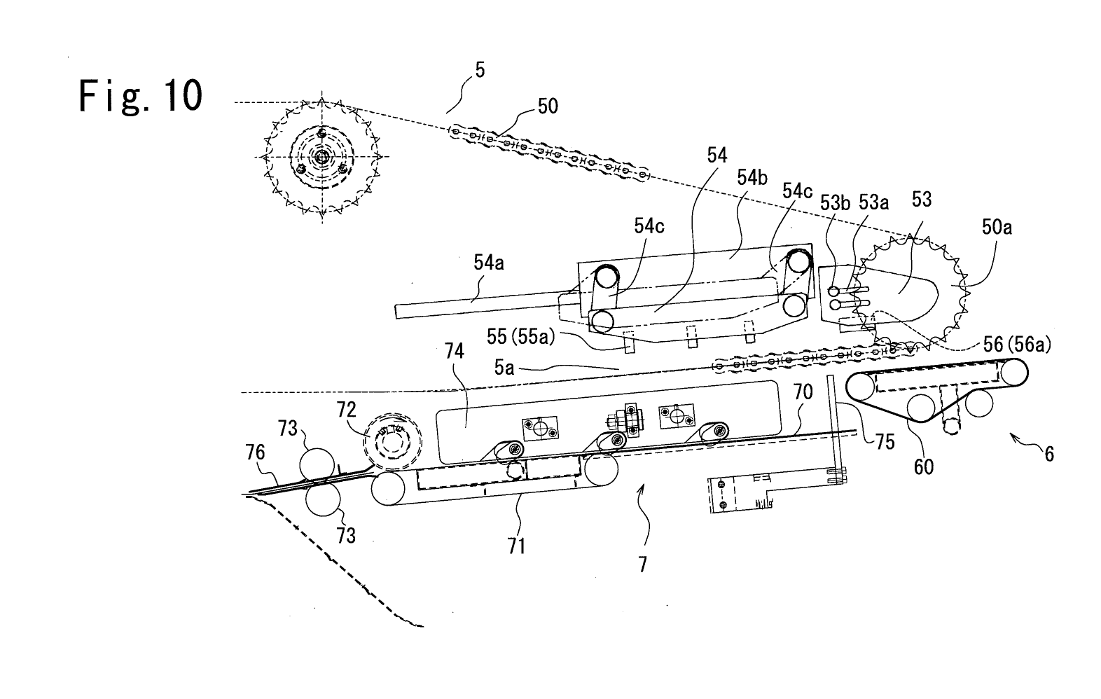

An example of the installation of the opening cam 54 for dropping will be explained based on FIG. 10

A cam guide 54a extending in the sheet carrying direction is installed at the sheet dropping position 5a. A cam attachment member 54b is installed to move along this cam guide 54a by an actuator not shown (motor and cylinder etc.), and the opening cam for dropping 54 is attached to this cam attachment member 54b by a link 54c.

The link 54c is swung in the vertical direction with an actuator not shown in the drawings. By swinging the link 54c downward, the opening cam for dropping 54 moves to the operating position as shown by a solid line. By swing the link 54c upwards, the opening cam for dropping 54 moves to the non-operating position as shown by an imaginary line.

The position in the sheet carrying direction of the opening cam for dropping 54 is adjusted by moving the cam attachment member 54b along the cam guide 54a.

The opening cam for ejection 53 is attached to the main body frame so as to be able to adjust its position in the carrying direction. For example, this opening cam for ejection 53 is attached to the main body frame by screwing a bolt 53b into the main body frame through a slot 53a extending in the carrying direction.

A drop auxiliary means 55 to apply a downward force to the sheet 2b when dropping the printed sheet 2b is installed at the sheet dropping position 5a. For example, a plurality of air nozzles 55a is arranged at intervals in the carrying direction and the lateral direction so as to spray air on the upper surface of the dropping sheet 2b.

A transfer auxiliary means 56 to assist the delivery of the printed sheet 2b to the delivery section 6 of is installed at the downstream side in the carrying direction than the sheet dropping position 5a. For example, a plurality of the fans 56a is arranged at intervals in the lateral direction so as to spray air on the upper surface of the printed sheet 2b.

In addition, a plurality of the chains 50 is arranged at intervals in the lateral direction and the transfer auxiliary means 56 is disposed between the chains 50 so as not to interfere with the chain 50 and sprocket 50a.

Next, the structure of the sheet carrying section for turnover 7 will be explained in detail based on FIG. 10.

The sheet carrying section for turnover 7 comprises a sheet receiving plate 70, a second suction conveyer 71, a suction roller 72, second feed rollers 73, a side jogger 74 and a stopper 75.

The sheet receiving plate 70 is located closer to the delivery section 6 in the lower part of the sheet dropping position 5a.

The second suction conveyer 71 is located closer to the sheet positioning section 3 in the lower part of the sheet dropping position 5a, and the second suction conveyer 71 and the sheet receiving plate 70 continue in the sheet carrying direction, and the one side printed sheet 2b is dropped onto them. The second suction conveyer 71 has the same structure as that of the first suction conveyer 20 previously explained.

The suction roller 72 is located closer to the downstream side in the sheet carrying direction of the second suction conveyer 71 and is close to the chain 50. The suction roller 72 rotates in the clockwise direction at the speed lower than the carrying speed of the one side printed sheet 2b by the chain 50. The suction roller 72 has a form of a cylinder which has a number of holes in the peripheral surface thereof and sucks the sheet 2b to the peripheral surface by sucking the air inside thereof and carries the sheet 2b by the rotation thereof.

A pair of the second feed rollers 73 is located at the downstream side in the sheet carrying direction of the suction roller 72 and carries the one side printed sheet 2b along the sheet guide 76 towards the sheet positioning section 3.

The side jogger 74 moves the sheet receiving plate 70 and the one side printed sheet 2b which is dropped onto the second suction conveyer 71 in the lateral direction.

The stopper 75 is located closer to the delivery section 6 and on the sheet receiving plate 70, against which the front end surface of the one side printed sheet 2b abuts. This stopper 75 is adjustable its position in the sheet carrying direction.

Then, a carrying operation of the one side printed sheet 2b to the sheet positioning section 3 will be explained.

When the one side printed sheet 2b which is gripped by the gripper 51 attached to the chain 50 arrives at the position near the sheet dropping position 5a, the one side printed sheet 2b is subjected to a downward force effected by the air shower from the air nozzles 55a, and is suck to the suction roller 72.

Since the suction roller 72 rotates clockwise at the sheet carrying speed lower than the carrying speed of the one side printed sheet 2b by the chain 50, that is, at the sheet carrying speed lower than the movement speed of the gripper 51 (clamp for sheet grapping) attached to the chain 50, the one side printed paper 2b which arrived at the neighborhood of the sheet dropping position is subjected to a force in the direction opposite to the sheet carrying direction by the suction roller 72 (in other words, braking carriage of the one side printed sheet 2b which is carried is applied by the suction roller 72). Because the transfer speed of the one side printed sheet 2b is reduced than the movement speed of the gripper 51 attached to the chain 50 when the gripper 51 attached to the chain 50 is opened by the opening cam 54 for dropping in this state, the one side printed sheet 2b is easy to drop out from the gripper 51 attached to chain 50.

In addition, the chain 50 and the suction roller 72 are not allowed to contact with each other to prevent the suction roller 72 from becoming an excessive brake for the sheet 2b which is not made to drop at the sheet dropping position 5a.

In addition, the back end of the one side printed sheet 2b (end of the sheet positioning section 3 side) can be dropped faster than the front end of the one side printed sheet 2b (end of the delivery section 6 side), because the suction roller 72 sticks the back end of the one side printed sheet 2b (end of the sheet positioning section 3 side) which is released and is dropped from the gripper 51 attached to the chain 50 and rotates clockwise to feed it towards the delivery section 6. This achieves the prevention of collision between the one side printed sheet 2b which is dropping and the one side printed sheet 2b which is conveyed with gripper 51.

Furthermore, an air shower by the air nozzles 55a acts on the upper surface of the one side printed sheet 2b which is released and dropped from the gripper 51 attached to the chain 50, and thereby affects the one side printed sheet 2b with the downward force and assist its drop. In this way, the dropping locus of the one side printed sheet 2b can be stabilized.

A fan can be used to affects the upper surface of the one side printed sheet 2b with the air shower too, but there are two ways in which the one side printed sheet 2b is made to drop or not to drop at the sheet dropping position 5a and to this end, there are provided two states in which the air shower is operated or is stopped to operate, therefore the air nozzle is more desirable than the fan.

By these, the sheet 2b may be dropped in more stable state than in dropping by the gravity.

In addition, since the front end edge of the one side printed sheet 2b dropped from the sheet dropping position 5a comes in contact with the stopper 75, the one side printed sheet 2b does not be dropped forward from the sheet receiving plate 70 even by the sheet carrying power. The positions in the sheet carrying direction of this stopper 75 and the opening cam 54 for dropping are adjusted depending on the top to bottom size of the sheet.

In addition, when the one side printed sheet 2b is on the way of dropping, or on the sheet receiving plate 70 or on the second suction conveyer 71 after dropping, the side jogger 74 is moved in one of the right or left direction only a short distance to move the one side printed sheet 2b in one of the right or left direction only the same distance so that the central position in the lateral direction of the one side printed sheet 2b is made to coincide with the central position 2b-1 in the lateral direction of the sheet 2b in the sheet supply section 2.

In other words, the side jogger 74 constitutes a means to move the printed sheet 2b which fell in the lateral direction. This is for the operation to move the one side printed sheet 2b in the lateral direction to position it in the lateral direction by the inclined suction conveyer 30b of the sheet positioning section 3 whom it passes later.

In other words, since the central position in the lateral direction of the one side printed sheet 2b fed by the chain 50 is identical with the central position in the lateral direction of the sheet 2b positioned in the sheet positioning section 3 and thereby the central position in the lateral direction of the one side printed sheet 2b which fell from the sheet dropping position 5a is off the central position 2b-1 in the lateral direction of the sheet 2b in the sheet supply section 2, the one side printed sheet 2b which fell from the sheet dropping position 5a is made to move in the lateral direction to make its central position in the lateral direction to coincide with the central position 2b-1 in the lateral direction of the sheet 2b in the sheet supply section 2.

The one side printed sheet 2b dropped is intermittently carried by the second suction conveyer 71. The second suction conveyer 71 is at a standstill=when the one side printed sheet 2b drops.

Therefore, the top and bottom register of the one side printed sheet 2b is stable as compared with that of the sheet 2b dropping on a conveyer during driving like in the printer disclosed in JP 2015-11178 A.

The start timing of driving of the second suction conveyer 71 is determined by the signal from the proximity sensor installed opposite to the gear which rotationally drives the transfer roller 40 as with the suction conveyer 20.

When the second suction conveyer 71 is driven, the one side printed sheet 2b is carried to the pair of the second feed rollers 73 which rotates at a constant speed.

And, the one side printed sheet 2b is carried by the second feed rollers 73 and is carried to the suction conveyers 30a, 30b of the sheet positioning section 3. Here, a structure is provided that the non-printed sheet 2b carried from the sheet supply section 2 and the one side printed sheet 2b carried from the second suction conveyer 71 are alternately carried to the sheet positioning section 3. According to this structure, the print of the front surface (one side) and print of the back surface (the other side) are alternately performed in the electro-photographic printing section 4.

In addition, for example, the sheet carrying speed of the pair of the feed rollers 73 is the same as the sheet carrying speed of the backup roller 41 and is prevented from varying from the sheet carrying speed of the backup roller 41.

In this embodiment, the one side printed sheet 2b is made to drop on the second suction conveyer 71 which is at a standstill and the non-printed sheet 2b carried from the sheet supply section 2 and the one side printed sheet 2b carried from the second suction conveyer 71 are alternately carried to the sheet positioning section 3 to enable the alternating print of the front and back surfaces thereof.

In the printer disclosed in JP 2015-11178 A, in order to perform an alternative printing, it is necessary to make the one side printed sheet drop between the non-printed sheets being carried over the conveyer. However, making the one side printed sheet drop on an aimed position on the conveyer while carrying the non-printed sheet is easily resulted in a positional displacement of the one side printed sheet with respect to the aimed position on the conveyer.

In addition, since it is difficult to stop dropping one side printed sheet without its slipping on the conveyer, there is a fear that the dropping one side printed sheet collides with and is piled up on the non-printed carried sheet, if an interval of the non-printed carried sheets is small.

Therefore, the carrying sheet interval must be made wide to eliminate the possibility of this fear, which results in the deterioration of the print efficiency.

With respect to the positional displacement mentioned above, since the dropping sheet is unstable and it is thereby difficult to control it, and then a time needed for a drop of the one side printed sheet does not vary basically, even if the carrying speed of the non-printed sheet changes, it is difficult to make the one side printed sheet drop to the aimed position on a conveyer while carrying the non-printed sheet.

The one side printed sheet 2b carried to the sheet positioning section 3 is transferred to the clamp 41a of the backup roller 41 as with the front surface printing, and the back surface thereof is printed by electro-photographic printing section 4.

In this embodiment, the diameter of the transfer roller 40 is twice the diameter of the backup roller 41, and quadruple of the diameter of the photoconductor drum 42a, and four transferred images (toner images) are formed on the peripheral surface of the transfer roller 40. Therefore, when the front and back surface printing are alternately carried out, the toner image of the same surface (in other words, the front surface or the back surface) is always formed on the surface layer of rubber material of the certain jacket 40b on the surface of the transfer roller 40.

In the wet type electro-photographic developing device, if cleaning of the transfer roller 40 with the cleaning unit 43 is insufficient, it may cause a fear that a phenomenon of reflection of previous toner image to a present toner image occurs, but such a phenomenon is inconspicuous because they are always the toner images on the same surface in this embodiment.

In other words, since a toner image for one side to be printed on the one side of the sheet 2b and a toner image for other side to be printed on the other side of the sheet 2b are alternately and circumferentially formed on even numbers of parts of the peripheral surface of the transfer roller 40, and thus the toner image for one side and the toner image for other side are always on the same parts of the peripheral surface of the transfer roller 40, respectively, the toner image for other side is not formed on the part on which the toner image for one side is formed.

In this way, even in cases where cleaning of transcription roller 40 is insufficient and the reflection of the toner image occurs, the reflection is inconspicuous.

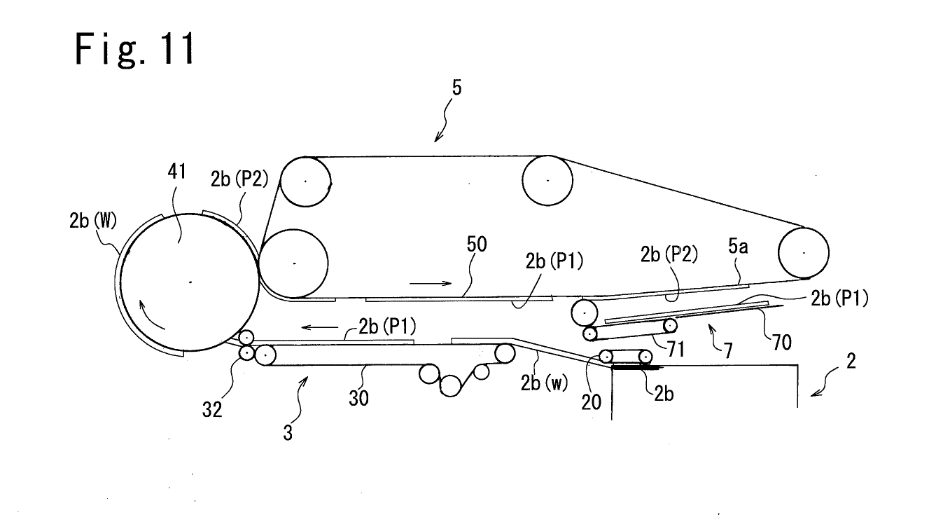

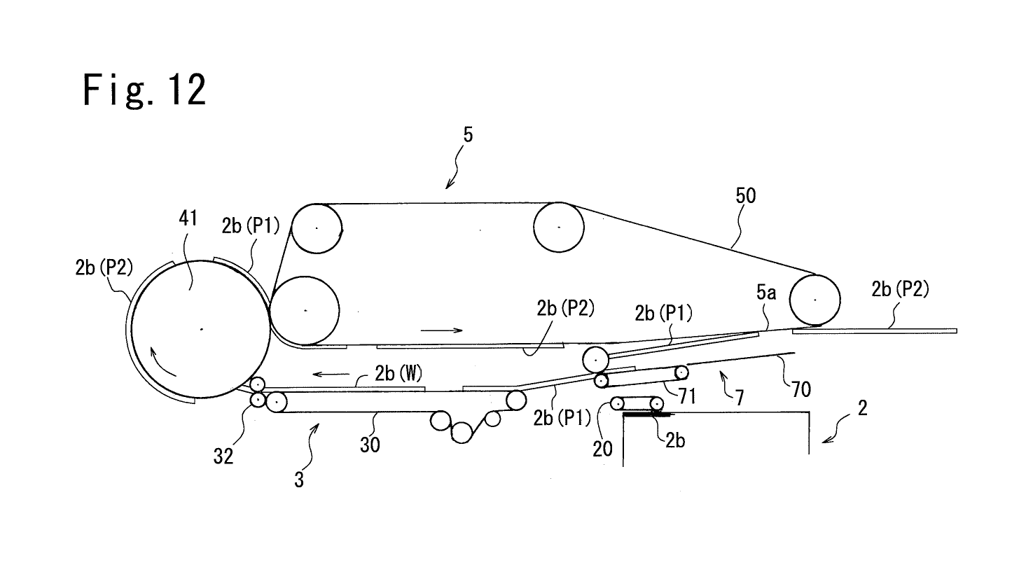

An outline of the duplex printing operation of this embodiment will be explained based on FIGS. 11 and 12.

In addition, on account of the explanation, in the following explanation, the sheet 2b is explained with being classified and referred to as non-printed sheet 2b (W), one side printed sheet 2b (P1) and both side printed sheet 2b (P2) by using other references.

As shown in FIG. 11, when the non-printed sheet 2b (W) is carried to the sheet positioning section 3 from the sheet supply section 2, the sheet positioning section 3 positions the one side printed sheet 2b (P1) and sends out it to the backup roller 41. At this time, the sheet carrying section for turnover 7 is at a standstill. With the backup roller 41, the one side of the non-printed sheet 2b (W) is printed and the both side printed sheet 2b (P2) of which the both sides have been printed is sent into the chain delivery section 5.

The chain delivery section 5 carries one piece of the both side printed sheet 2b (P2) and one piece of the one side printed sheet 2b (P1). The sheet carrying section for turnover 7 waits for sending out while supporting one piece of the one side printed sheet 2b (P1). This state is changed to the state as shown in FIG. 12 because each of the sections carries the sheets 2b (W), 2b (P1) and 2b (P2).

The state as shown in FIG. 12, the sheet supply section 2 is a standstill and does not carry the non-printed sheet 2b (W), but the one side printed sheet 2b (P1) is sent into the sheet positioning section 3 from the sheet carrying section for turnover 7. The sheet positioning section 3 sends out the non-printed sheet 2b (W) to the backup roller 41. With the backup roller 41, the one side printed sheet 2b (P1) is printed on its other side to make a double side printed sheet 2b (P2) and the one side printed sheet 2b (P1) is sent out to the chain delivery section 5.

In the chain delivery section 5, one piece of the both side printed sheet 2b (P2) is carried and one piece of the one side printed sheet 2b (P1) is dropped on the sheet carrying section for turnover 7 and one piece of the both side printed sheet 2b (P2) is carried to the delivery section 6.

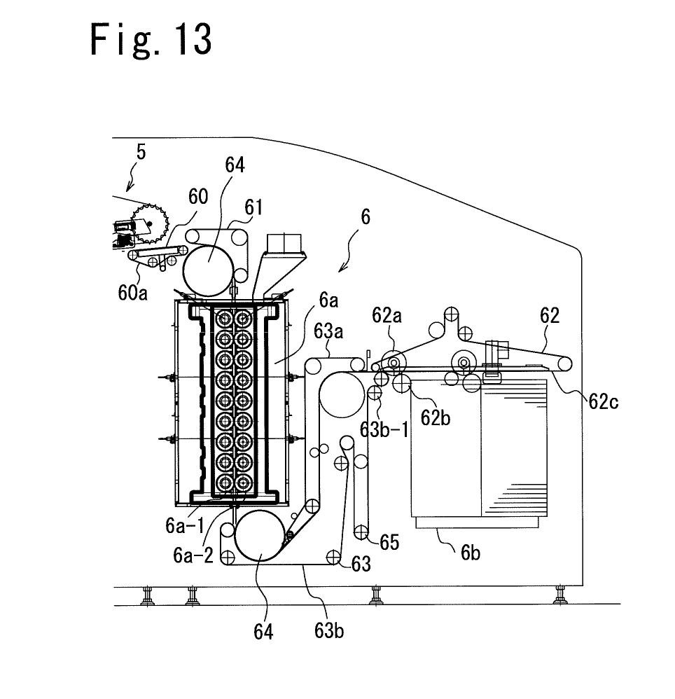

Then, the structure of the delivery section 6 with its operation will be explained in detail based on FIG. 13.

The delivery section 6 comprises a suction conveyer 60 for ejection installed below a ejection position of the chain delivery section 5, a first carrying conveyer 61 installed between the suction conveyer 60 for ejection and an entrance side of the fixing device 6a and a second carrying conveyer 63 installed between an exit side of the fixing device 6a and a stacker 62. The ejection position is the position where the gripper 51 is made to open by the opening cam for ejection 53 and the printed sheet (one side printed sheet 2b (P1) in the case of the one side printing, both side printed sheet 2b (P2)) in the case of the duplex printing) is dropped.

When the printed sheet 2b (P1) or 2b (P2) on which printing was completed is ejected into the delivery section 6, the opening cam for dropping 54 of the chain delivery section 5 is moved to the non-operating position and thus gripper 51 is not opened to prevent the printed sheet 2b (P1) or 2b (P2) from dropping at the sheet dropping position 5a. Thereafter, the gripper 51 is opened by the opening cam for ejection 53 to allow the printed sheet 2b (P1) or 2b (P2) to drop on the suction conveyer 60 for ejection.

In addition, in the case of this embodiment, a fan 56a is installed above the chain 50 at the ejection position, where the printed sheet 2b (P1) or 2b (P2) is allowed to drop on by the opening cam for ejection 53.

And, an air shower by the fan 56a acts on the upper surface of the printed sheet 2b (P1) or 2b (P2) to stabilize the dropping locus of the printed sheet 2b (P1) or 2b (P2) which is allowed to drop by opening of the gripper 51 of the chain 50 at the ejection position.

Since the both side printed sheet 2b (P2) and the one side printed sheet 2b (P1) are alternately carried in the duplex printing as described above, the dropping one side printed sheet 2b (P1) and the both end printed sheet 2b (P2) sent to the delivery section 6 are alternately carried at the sheet dropping position 5a of the chain delivery section 5.

Therefore, the opening cam for dropping 54 repeats its movement from the operating position to the non-operating position for every other sheet. The air nozzle 55a repeats an air shower (an ejection and stop of the air) in regular intervals.

In addition, in the duplex printing, only the both side printed sheet 2b (P2) to be carried to the delivery section 6 is carried to the ejection position where the sheet is allowed to drop by the opening cam for ejection 53. And, the fan 56a always operates to make an air shower act because the opening cam for ejection 53 is fixed.

The suction conveyer for ejection 60 sucks out air from a number of holes made in the belt 60a to make the printed sheet 2b (P1) or 2b (P2) stuck to the belt 60a and carries while sucking them to the belt 60a. The printed sheet 2b (P1) or 2b (P2) is sent into the fixing device 6a by the first carrying conveyer 61. The toner image is completely fixed on the printed sheet 2b (P1) or 2b (P2) where the printed sheet 2b (P1) or 2b (P2) passes through the fixing device 6a.

The fixing device 6a comprises a number of the fixing roller pairs which each is composed of a fixing roller 6a-1 having a heater inside and a fixing roller 6a-2 having a heater inside which make a pair, so as to contact with the front and back surfaces of the printed sheet 2b (P1) or 2b (P2), and the toner images on the front surface or the back surface or the front and back surfaces are fixed at the same time where the printed sheet 2b (P1) or 2b (P2) passes through between these fixing roller pairs.

In this embodiment, each of the fixing rollers 6a-1, 6a-2 has the heater of the short wavelength in its center and performs fixing by heat of the heater. Generally, the temperature of the fixing device decreases when the printed sheet 2b (P1) or 2b (P2) passes through the fixing device, because the heat is absorbed by the printed sheet 2b (P1) or 2b (P2). Therefore, a difference in degree of fixing is caused, because the temperature in the fixing device varies according to the interval of passing of the printed sheet 2b (P1) or 2b (P2) through the fixing device. However, in this embodiment, the printed sheet 2b (P1) or 2b (P2) passes through the fixing device 6a at regular intervals by printing the one side and the other side alternately, therefore fixing can be performed at a constant temperature.

In addition, cooling rollers 64 are installed at the entrance side (the upstream side) and the exit side (the downstream side) of the fixing device 6a, respectively, but these rollers may be usual rollers.

The printed sheet 2b (P1) or 2b (P2) having passed through the fixing device 6a is clamped by a pair of upper and lower carrying conveyers 63a, 63b of the second carrying conveyer 63 and carried up to a front side of=the upper part of the elevating table 6b.

Because a dancer roller 65 is installed in the lower carrying conveyer 63b, a roller 63b-1 at the downstream edge of the lower carrying conveyer 63b is movable together with a duster 62a and a suction roller 62b of the stacker 62 from the front side (the fixing device 6a side) to the midpoint as shown by the imaginary line above the elevating table 6b according to the top to bottom size of the printed sheet 2b (P1) or 2b (P2). By these, the printed sheet 2b (P1) or 2b (P2) is supported from the underside and carried. In other words, the back side of the elevating table 6b (the side opposite to the fixing device 6a) is a reference position where the printed sheet 2b (P1) or 2b (P2) is piled up.

Furthermore, a suction conveyer 62c is installed at the downstream side of the upper carrying conveyer 63a on much the same level therewith. This suction conveyer 62c assists that the front end edge in the carrying direction of the printed sheet 2b (P1) or 2b (P2) arrives at the reference position of the back side of the elevating table 6b particularly in cases of the printed sheet 2b (P1) or 2b (P2) when it is thin.

The suction conveyer 62c continuously attracts the printed sheet 2b (P1) or 2b (P2) by suction power of the degree not to disturb a drop thereof and makes the front end edge in the carrying direction of the printed sheet 2b (P1) or 2b (P2) arrive at the reference position (stopper not shown) in the back side of the elevating table 6b.

The front end edge in the carrying direction of the printed sheet 2b (P1) or 2b (P2) carried in this way arrives at the reference position, and then the printed sheet 2b (P1) or 2b (P2) is dropped on the elevating table 6b. However, there is a fear that the printed sheet 2b (P1) or 2b (P2) might collide with the following printed sheet 2b (P1) or 2b (P2), if this drop process requires an amount of time.

For this reason, the back side (the rear end side in the carrying direction) of the printed sheet 2b (P1) or 2b (P2) is made to drop quickly by swatting the back side of the printed sheet 2b (P1) or 2b (P2) from above with the duster 62a and attracts the printed sheet 2b (P1) or 2b (P2) from the underside by the suction roller 62b when making it drop.

In addition, the one side printing with the duplex printing machine of this embodiment will be explained.

In other words, when the one side printing is performed, the chain delivery section 5 is always set in the first state to successively send the printed sheet 2b (P1) to the delivery section 6. The machine is made into the state that the turnover carrying section 7 comes to a stop and the suction roller 72 does not attract the printed sheet.

And, the sheet supply section 2 is continuously driven to successively send the non-printed sheet 2b (W) to the sheet positioning section 3.

The non-printed sheet 2b (W) sent to the sheet positioning section 3 is positioned as with a duplex printing, and the non-printed sheet 2b (W) positioned is sent to the electro-photographic printing section 4. In the electro-photographic printing section 4, the one side of the non-printed sheet 2b (W) sent is printed and the printed sheet 2b (P1) which one side is printed is transferred to the chain delivery section 5.

In the chain delivery section 5, the one side printed sheet 2b (P1) is successively carried to the delivery section 6 by opening the gripper 51 with the opening cam for ejection 53. At this time, the opening cam for dropping 54 is at the non-operating position and thus does not open the gripper 51. Because the suction roller 72 stops its drive and thus does not attract the sheet carried with the chain delivery section 5, the one side printed sheet 2b (P1) is smoothly carried.

The toner image on the one side printed sheet 2b (P1) sent to the delivery section 6 is fixed by the fixing device 6a as with a duplex printing and thereafter the one side printed sheet 2b (P1) is loaded on the elevating table 6.

The one side printed sheet 2b (P1) is continuously produced from the non-printed sheet 2b (W) by performing this operation in succession.

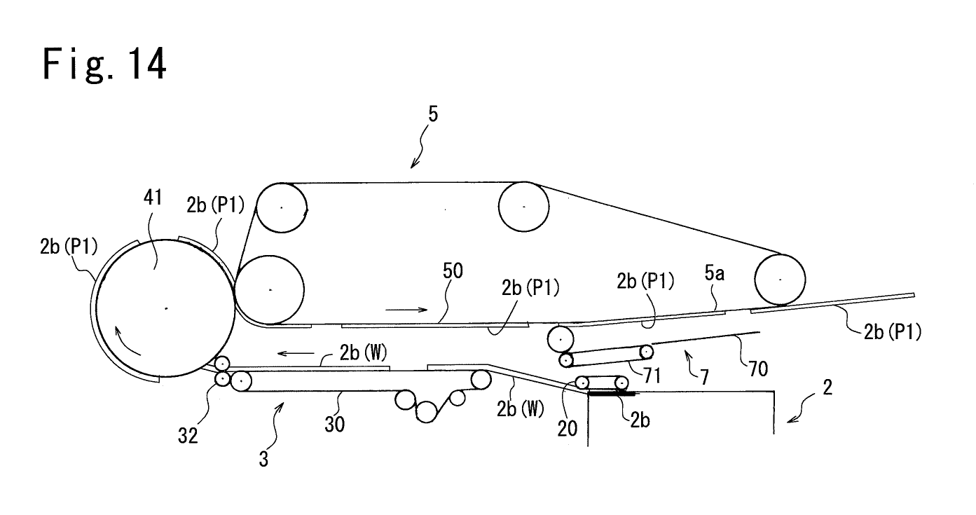

The carrying state of the sheet at this time is as shown in FIG. 14.

What is claimed is:

1. An electro-photographic sheet of paper duplex printing machine having a sheet supply section, a sheet positioning section, an electro-photographic printing section, a chain delivery section and a delivery section arranged in order from upstream to downstream in a direction of carriage of sheets of paper, and having a sheet carrying section for turnover disposed above the sheet supply, wherein
the sheet supply section sends out sheets one by one onto the sheet positioning section,
the sheet positioning section positions the sheets and sends out positioned sheets to a backup roller in the electro-photographic printing section,
the electro-photographic printing section prints a toner image on a sheet transferred onto the transfer roller onto the sheet on the backup roller by transferring the toner image,
the chain delivery section selectively transfers printed sheets transferred from the backup roller to the delivery section or the sheet carrying section for turnover,
the delivery section has a fixing device for fixing the toner image,
the sheet carrying section for turnover is supplied with one side printed sheet dropped from the chain delivery section, and supplies the one side printed sheet to the sheet positioning section by a suction conveyer which is intermittently driven, and
the sheet fed from the sheet supply section and the one side printed sheet carried from the sheet carrying section for turnover are alternately carried to the sheet positioning section, and the printed sheet passes through the fixing device in the delivery section at regular intervals.

2. An electro-photographic sheet of paper duplex printing machine as set forth in claim 1, wherein
the sheet positioning section has a suction conveyer carrying the sheet at a constant speed and a pair of upper and lower registration rollers, the backup roller has a sheet support, the sheet horizontally carried by the suction conveyer in the sheet positioning section horizontally enters the pair of upper and lower registration rollers and comes to a stop when coming in contact with the contact portions of the pair of upper and lower registration rollers, and the sheet is carried to the sheet support of the backup roller by the rotation of the pair of upper and lower registration rollers.

3. An electro-photographic sheet of paper duplex printing machine as set forth in claim 1, wherein
the suction conveyer in the sheet positioning section comprises a straight suction conveyer which is located in parallel to the carrying direction of the sheet sent out from the sheet supply section and an inclined suction conveyer which is located at an inclination with respect to the carrying direction of the sheet, and
air suction power of the inclined suction conveyer is stronger than air suction power of the straight suction conveyer.

4. An electro-photographic sheet of paper duplex printing machine as set forth in claim 2, wherein
the suction conveyer in the sheet positioning section comprises a straight suction conveyer which is located in parallel to the carrying direction of the sheet sent out from the sheet supply section and an inclined suction conveyer which is located at an inclination with respect to the carrying direction of the sheet, and
air suction power of the inclined suction conveyer is stronger than air suction power of the straight suction conveyer.

5. An electro-photographic sheet of paper duplex printing machine as set forth in claim 1, wherein
a drop auxiliary means to apply a downward force to the sheet when making the sheet drop is installed at the sheet dropping position where the sheet is dropped from the chain delivery section to the sheet carrying section for turnover, and
the sheet carrying section for turnover has a means to move the printed sheet in the direction orthogonal to the carrying direction.

6. An electro-photographic sheet of paper duplex printing machine as set forth in claim 2, wherein
a drop auxiliary means to apply a downward force to the sheet when making the sheet drop is installed at the sheet dropping position where the sheet is dropped from the chain delivery section to the sheet carrying section for turnover, and
the sheet carrying section for turnover has a means to move the printed sheet in the direction orthogonal to the carrying direction.

7. An electro-photographic sheet of paper duplex printing machine as set forth in claim 3, wherein
a drop auxiliary means to apply a downward force to the sheet when making the sheet drop is installed at the sheet dropping position where the sheet is dropped from the chain delivery section to the sheet carrying section for turnover, and
the sheet carrying section for turnover has a means to move the printed sheet in the direction orthogonal to the carrying direction.

8. An electro-photographic sheet of paper duplex printing machine as set forth in claim 4, wherein
a drop auxiliary means to apply a downward force to the sheet when making the sheet drop is installed at the sheet dropping position where the sheet is dropped from the chain delivery section to the sheet carrying section for turnover, and
the sheet carrying section for turnover has a means to move the printed sheet in the direction orthogonal to the carrying direction.
